(19) United States
(12) Patent Application Publication
(10) Pub. No.: US 2004/0016001 A1
(43) Pub. Date: Jan. 22, 2004

(54) CATV tuner

(75) Inventors: Koji Kawano, Shiga-ken (JP); Yoshikazu Shimamura, Ritto-shi (JP)

Correspondence Address: Keating & Bennet LLP, Suite 312, 10400 Eaton Place, Fairfax, VA, 22030, US

(73) Assignee: Murata Manufacturing Co., Ltd., Nagaokakyo-shi (JP)

(21) Appl. No.: 10/615,092

(22) Filed: Jul. 7, 2003

(30) Foreign Application Priority Data
Jul. 22, 2002 (JP) 2002-212486

(51) Int. Cl. H04N 7/173; H04N 7/16

(52) U.S. Cl. 725/151; 725/127

(57) ABSTRACT

A CATV tuner includes a tuner box including an input circuit, a first mixer circuit, a first oscillation circuit, a first IF circuit, a second mixer circuit, a second oscillation circuit, and a second IF circuit. The input circuit has an input terminal, an upstream-signal input terminal, and a bandpass filter provided therebetween. The input terminal is connected to a distributor via a high-pass filter. An output from one output end of the distributor is subjected to processing such as filtering, amplifying, and so forth, and transmitted to the first mixer circuit. The other output end of the distributor is connected to a downstream-signal output terminal via a low-pass filter and an amplifier.

### BACKGROUND OF THE INVENTION

1. Field of the Invention

The present invention relates to a CATV tuner and more particularly, relates to a CATV tuner used for providing communications service such as Internet access and interactive service such as video on-demand.

2. Description of the Related Art

FIG. 4 is a block diagram of a CATV tuner 1 shown for the purpose of describing the background of the present invention. This CATV tuner 1 has an input terminal 2 to which an input circuit 3 is connected. This input circuit 3 receives a CATV signal (54 to 864 MHz) transmitted from a CATV station. This CATV signal is transmitted to a first mixer circuit 4. A first oscillator circuit 5 is connected to the first mixer circuit 4. In the first mixer circuit 4, the CATV signal transmitted from the input circuit 3 and a first oscillation signal transmitted from the first oscillation circuit 5 are mixed, whereby a first intermediate-frequency signal (hereinafter referred to as an IF signal) is obtained. The obtained first IF signal is transmitted to a first intermediate-frequency circuit 6 (hereinafter refereed to as a first IF circuit 6) and subjected to processing such as filtering, amplifying, and so forth.

An output signal from the first IF circuit 6 is transmitted to a second mixer circuit 7. A second oscillation circuit 8 is connected to the second mixer circuit 7. In the second mixer circuit 7, an output signal transmitted from the first IF circuit 6 and a second local-oscillation signal transmitted from the second oscillation circuit 8 are mixed, whereby a second IF signal is generated. The second IF signal is transmitted to a second IF circuit 9 and subjected to processing such as filtering, amplifying, and so forth. The second IF circuit 9 is connected to an output terminal 10.

The CATV tuner 1 can select a signal of a predetermined channel from among signals of a plurality of channels, which is typical for a conventional tuner. Furthermore, the CATV tuner 1 can have predetermined functions and a predetermined configuration so as to provide communications service such as Internet access, interactive service such as video on-demand, online shopping, and so forth. For receiving the above-described service, a set-top box (hereinafter referred to as an STB) is used for providing various CATV functions.

Further, for receiving the above-described service, an upstream signal (8 MHz to 26.5 MHz) is transmitted from the input circuit 3 to the CATV station. The upstream signal is input from the STB to an upstream-signal input terminal 11 of the input circuit 3, as shown in FIG. 5. The input upstream signal is transmitted to the CATV station via the bandpass filter 12. The bandpass filter 12 attenuates the harmonic content of the upstream signal and prevents backflow of a signal of each channel to the upstream-signal input terminal 11.

The CATV station transmits a downstream signal (70 MHz to 130 MHz) including data used for controlling the STB, for example. The input terminal 2 is connected to a high-pass filter 13 used for blocking the upstream signal, and the high-pass filter 13 is connected to a distributor 14. An output from one output end of the distributor 14 is subjected to processing such as filtering, amplifying, and so forth, and transmitted to the first mixer circuit 4. The other output end of the distributor 14 is connected to a downstream-signal output terminal 15. When the distributor 14 distributes a reception signal, one of the distributed signals is output from the downstream-signal output terminal 15 as a downstream signal. The downstream signal transmitted from the downstream-signal output terminal 15 is amplified by an amplifier 16 and transmitted to the STB. The STB extracts the data transmitted from the CATV station. Since the upstream signal has a frequency lower than that of the signal transmitted from the CATV station, the upstream signal superimposed on the CATV signal is prevented from being input to the distributor 14 by the high-pass filter 13.

As has been described, in the case of the CATV tuner 1, which is an example of a known CATV tuner, the downstream signal from the downstream-signal output terminal 15 is transmitted to the STB via the amplifier 16 outside the CATV tuner 1. Therefore, noise generated in the STB may flow into wiring between the downstream-signal output terminal 15 and the amplifier 16 that are provided outside the CATV tuner 1. In this case, the noise entering into the wiring is amplified by the amplifier 16, whereby the S/N ratio of the downstream signal output from the amplifier 16 is deteriorated.

In the case of known CATV tuners, wiring between an input terminal for receiving a signal from a CATV station and an upstream-signal input terminal has to be provided near wiring between a distributor and an amplifier due to the circuit design. Since the amplifier is provided outside the CATV tuner, wiring has to be provided inside and outside the CATV tuner. Subsequently, the length of the wiring between the distributor and the amplifier increases. Further, since the level of an upstream signal is higher than that of a downstream signal, the upstream signal tends to flow into the wiring between the distributor and the amplifier. If the upstream signal flows into the wiring between the distributor and the amplifier, the harmonic of the upstream signal interferes with the downstream signal.

The downstream signal is not the only signal transmitted from a downstream signal output terminal but signals of all channels are output therefrom and input to the amplifier. Consequently, multi-wave distortion (intermodulation distortion, composite triple beat, cross-modulation distortion, and so forth) occurs in the downstream signal.

The high-pass filter attenuates the upstream signal and prevents it from being input to the distributor. However, since the frequency of the signal transmitted from the CATV station and that of the upstream signal are close to each other, it is difficult to increase the attenuation capability of the high-pass filter. If the attenuation capability increases, insertion loss on the first-mixer-circuit side increases and the NF characteristic of the CATV tuner deteriorates, whereby the reception capability of the CATV tuner deteriorates. Consequently, some upstream signals are not attenuated to an adequate level and input to the amplifier via the high-pass filter and the distributor. In this case, if the frequencies of harmonic content of the upstream signals agree with the frequency of the downstream signal, they interfere with the downstream signal. In particular, secondary and tertiary harmonics become the cause of the interference due to the level thereof.

### SUMMARY OF THE INVENTION

In order to overcome the problems described above, preferred embodiments of the present invention provide a CATV tuner that prevents noise and an upstream signal from flowing into a downstream side and that reduces distortion of a downstream signal, the distortion being generated by a CATV signal.

A CATV tuner according to a preferred embodiment of the present invention includes an input circuit connected to an input terminal for transmitting and receiving a signal to and from a CATV station. The input circuit includes an upstream-signal input terminal, a distributor, a low-pass filter, an amplifier, and a downstream-signal output terminal. The CATV tuner also includes a first mixer circuit for mixing an output signal from the input circuit and a first local-oscillation signal so as to generate a first IF signal, a first oscillation circuit for transmitting the first local-oscillation signal to the first mixer circuit, a first IF circuit for processing the first IF signal, a second mixer circuit for mixing an output signal from the first IF circuit and a second local-oscillation signal so as to generate a second IF signal, and a second oscillation circuit for transmitting the second local-oscillation signal to the second mixer circuit, and a second IF circuit for processing the second IF signal. At least one upstream signal is input to the upstream-signal input terminal so as to be transmitted to the CATV station. The distributor distributes a reception signal and transmits one of the distributed signals to the downstream-signal output terminal as a downstream signal so that the downstream signal is output therefrom. The amplifier is provided between the distributor and the downstream-signal output terminal so as to amplify the downstream signal. The low-pass filter is provided between the distributor and the amplifier so as to remove a CATV signal that has a frequency that is higher than a predetermined upper limit frequency of the downstream signal.

The CATV tuner may further include a high-pass filter between the distributor and the amplifier so as to block the upstream signal. The high-pass filter and the low-pass filter may define a bandpass filter.

The CATV tuner may further include a resistor between the amplifier and the downstream-signal output terminal.

According to the above-described configuration, since the amplifier is provided between the distributor and the downstream-signal output terminal, the amplifier is provided in a tuner case. Therefore, noise generated in the STB outside the tuner case is prevented from being transmitted in air and into the tuner case.

Further, since the amplifier is provided in the tuner case, the length of wiring between the distributor and the amplifier decreases. Subsequently, the upstream signal is prevented from flowing into the wiring.

Since the low-pass filter is provided between the distributor and the amplifier, the wave number of the CATV signal that is input to the amplifier is limited and multi-wave distortion generated in the amplifier is greatly reduced.

The low-pass filter functions as a matching circuit for causing the downstream signal transmitted from the distributor to be suitable to be input to the amplifier. Subsequently, gain-frequency deviation of the downstream signal caused by mismatch is reduced.

Further, by providing the high-pass filter between the distributor and the amplifier, the upstream signal input to the amplifier via the distributor can be attenuated to an adequate level and is prevented from being transmitted to the downstream side. Further, the downstream signal is prevented from being disturbed by the harmonic content of the upstream signal. Since the high-pass filter is provided on the downstream side, the insertion loss on the CATV-signal processing side does not increase.

Further, the resistor is provided between the amplifier and the downstream-signal output terminal. Therefore, the reflection characteristic of the amplifier from the standpoint of the downstream-signal output terminal improves due to resistor damping. Further, the gain-frequency deviation at the downstream-signal output terminal can be further reduced.

Other features, elements, characteristics and advantages of the present invention will become more apparent from the following detailed description of preferred embodiments of the present invention.

### BRIEF DESCRIPTION OF THE DRAWINGS

FIG. 1 is a block diagram of an example CATV tuner according to a preferred embodiment of the present invention;

FIG. 2 is a block diagram of an example input circuit that can be used for the CATV tuner of preferred embodiments of the present invention;

FIG. 3 is a block diagram of another example input circuit that can be used for the CATV tuner of preferred embodiments of the present invention;

FIG. 4 is a block diagram of an example known CATV tuner; and

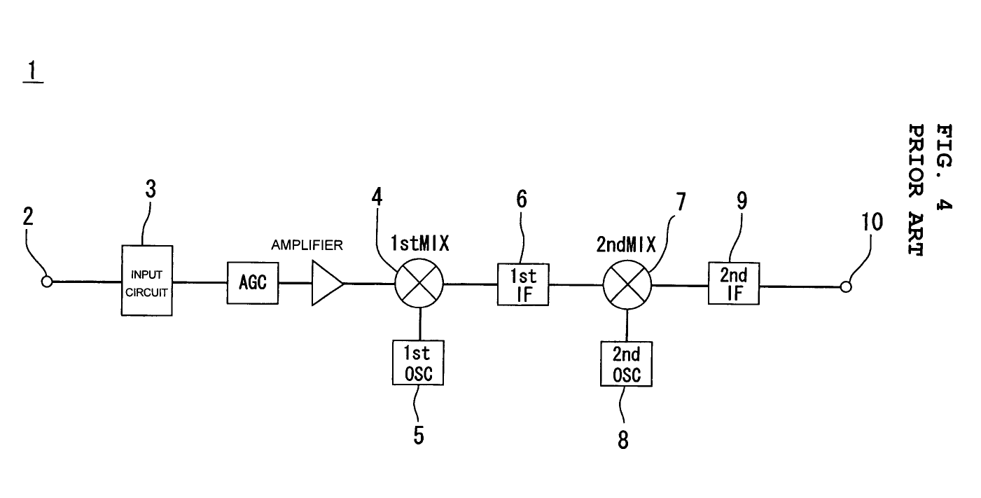

FIG. 5 is a block diagram of an example input circuit used for the example known CATV tuner.

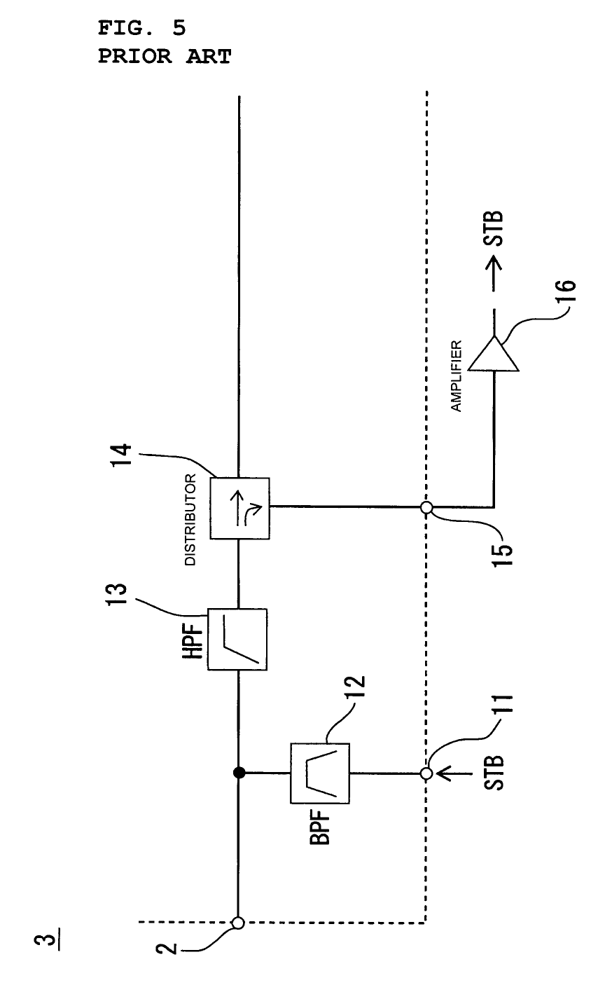

### DETAILED DESCRIPTION OF PREFERRED EMBODIMENTS

Preferred embodiments of the present invention will now be described in detail with reference to the attached drawings. The above-described features, elements, characteristics and advantages of the present invention will be disclosed below.

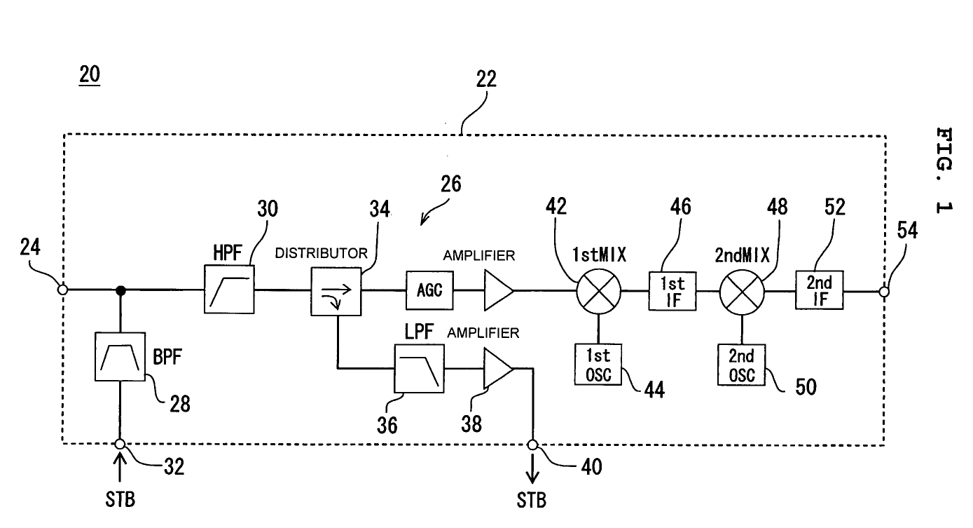

FIG. 1 is a block diagram of an example CATV tuner according to a preferred embodiment of the present invention. This CATV tuner indicated by reference numeral 20 includes a tuner case 22. In this tuner case 22, an input terminal 24 is provided and connected to an input circuit 26. This input circuit 26 includes a bandpass filter 28 and a high-pass filter 30. One end of the bandpass filter 28 is connected to an upstream-signal input terminal 32 provided in the tuner case 22, and the other end of the bandpass filter 28 is connected to the input terminal 24. One end of the high-pass filter 30 is connected to the input terminal 24, and the other end thereof is connected to a distributor 34.

An output from one end of the distributor 34 is transmitted to a downstream-signal output terminal 40 via a low-pass filter 36 and an amplifier 38. An output from the other end of the distributor 34 is subjected to processing such as filtering, amplifying, and so forth, and transmitted to a first mixer circuit 42. The first mixer circuit 42 is connected to a first oscillator circuit 44. An output terminal of the first mixer circuit 42 is connected to a first IF circuit 46.

The first IF circuit 46 is connected to a second mixer circuit 48. The second mixer circuit 48 is connected to a second oscillator circuit 50. An output terminal of the second mixer circuit 48 is connected to a second IF circuit 52. The second IF circuit 52 is connected to an output terminal 54.

This CATV tuner 20 can select a predetermined channel from among a plurality of channels. Further, the CATV tuner 20 can provide communications service such as Internet access and interactive service such as video on-demand, online shopping, and so forth.

A signal transmitted from a CATV station is input from the input terminal 24 to the input circuit 26. The reception signal input from the input terminal 24 is transmitted to the distributor 34 via the high-pass filter 30. The distributor 34 distributes the reception signal into two signals. One of the signals is transmitted to the first mixer circuit 42 and the other is transmitted to the low-pass filter 36.

In the mixer circuit 42, the signal transmitted from the distributor 34 and a first local-oscillation signal transmitted from the first oscillator circuit 44 are mixed, whereby a first IF signal is generated. Then, the mixer circuit 42 transmits the first IF signal whose frequency is higher than that of the reception signal. At this time, channel selection is performed by the first local-oscillation signal. The first IF signal is transmitted to the first IF circuit 46 and subjected to processing such as filtering, amplifying, and so forth.

The signal processed by the first IF circuit 46 is transmitted to the second mixer circuit 48 and mixed with a second local-oscillation signal transmitted from the second oscillation circuit 50, whereby a second IF signal whose frequency is lower than that of the reception signal is generated. The second mixer circuit 48 transmits the second IF signal to the second IF circuit 52. The second IF signal is subjected to processing such as filtering, amplifying, and so forth, in the second IF circuit 52, and transmitted to the output terminal 54.

An upstream signal transmitted to the CATV station for receiving various types of service is input from the STB to the upstream-signal input terminal 32 and transmitted to the input terminal 24 via the bandpass filter 28. Since the frequency of the upstream signal is lower than that of the signal transmitted from the CATV station, the upstream signal is attenuated by the high-pass filter 30 and prevented from being input to the distributor 34.

The other signal distributed by the distributor 34 is input to the amplifier 38 via the low-pass filter 36 and amplified. The amplified signal is transmitted from the downstream-signal output terminal 40 to the STB. It should be noted that the signals and output from the distributor 34 include a downstream signal for controlling the STB and a channel signal. The low-pass filter 36 removes a CATV signal within a frequency band higher than a predetermined upper-limit frequency of the downstream signal. Subsequently, only signals having a frequency within the frequency band of the downstream signal is transmitted to the STB.

In this CATV tuner 20, the amplifier 38 is preferably located between the distributor 34 and the downstream-signal output terminal 40. The amplifier 38 is accommodated in the tuner case 22. Therefore, noise generated in the STB outside the tuner case 22 is blocked by the tuner case 22 and prevented from being input to an input terminal of the amplifier 38. Therefore, the noise is prevented from being amplified by the amplifier 38 and the S/N ratio of the downstream signal does not deteriorate.

Further, since the amplifier 38 is provided in the tuner case 22, the length of wiring between the distributor 34 and the amplifier 38 is smaller than in the case where the amplifier 38 is provided outside the tuner case 22. Therefore, the upstream signal resists flowing into the wiring between the distributor 34 and the amplifier 38, whereby interference with the downstream signal is reduced.

Further, since the low-pass filter 36 is provided between the distributor 34 and the amplifier 38, the wave number of a CATV signal input to the amplifier 38 is limited. Therefore, multi-wave distortion generated in the amplifier 38 can be reduced. The low-pass filter 36 functions as a matching circuit for making the downstream signal transmitted from the distributor 34 suitable to be input to the amplifier 38. Subsequently, it becomes possible to reduce gain-frequency deviation of the downstream signal (gain variation in different frequencies within the frequency band of the downstream signal) caused by mismatch.

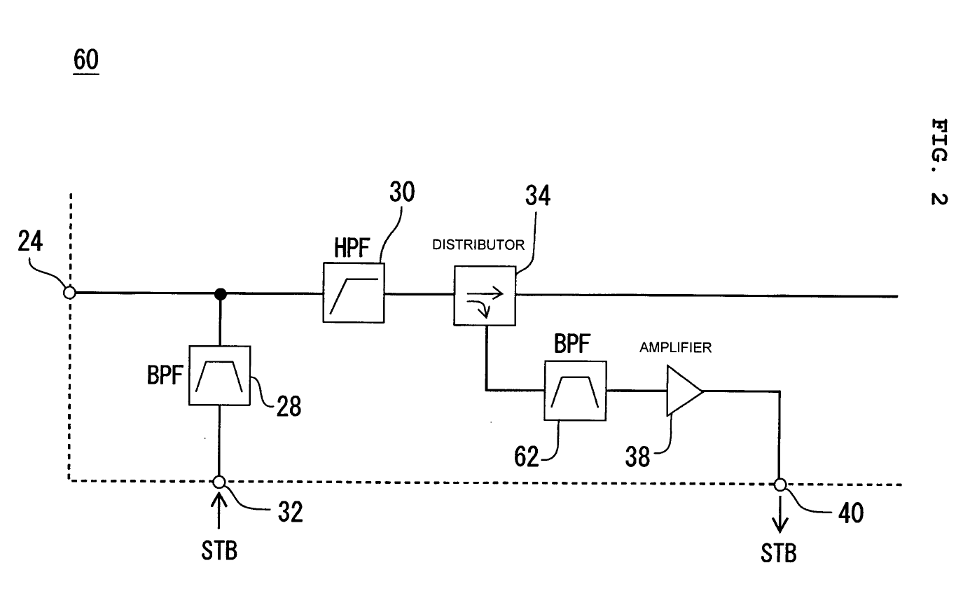

Further, in this CATV tuner 20, an input circuit 60 having another high-pass filter between the distributor 34 and the amplifier 38 can be used in place of the input circuit 26 shown in FIG. 1. The high-pass filter and the low-pass filter 36 define a bandpass filter 62, as shown in FIG. 2. In this case, it becomes possible to attenuate the upstream signal to a suitable level that could not be attenuated to the suitable level by the high-pass filter 30, the high-pass filter 30 being provided immediately before the distributor 34. Further, it becomes possible to reduce the leakage of the upstream signal to the downstream side. Consequently, the downstream signal is prevented from being disturbed by the harmonic content of the upstream signal. Since the bandpass filter 62 is not provided on the side of the first mixer circuit 42, the insertion loss on the CATV-signal processing side does not increase, and the deterioration of the NF characteristic of the CATV tuner is reduced. The bandpass filter 62 is not necessarily defined by two filters such as the low-pass filter 36 and the high-pass filter as in the above-described case, but can be defined by a single bandpass filter.

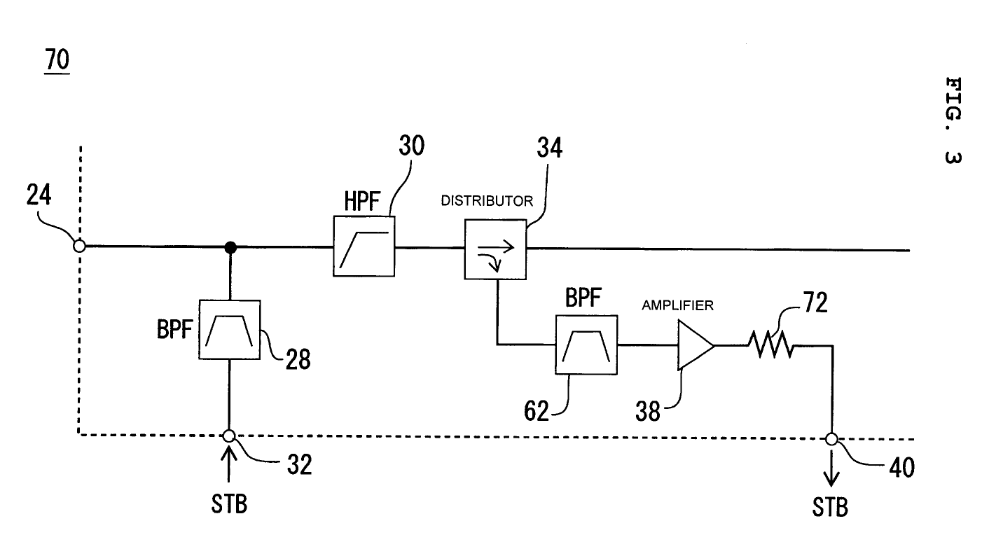

Further, in this CATV tuner 20, an input circuit 70 shown in FIG. 3 having a resistor 72 inserted between the amplifier 38 and the downstream-signal output terminal 40 can be used in place of the input circuit 26. By the use of the resistor 72, the reflection characteristic of the amplifier 38 from the standpoint of the downstream-signal output terminal 40 improves due to resistor damping, and the gain-frequency deviation at the downstream-signal output terminal 40 can be further reduced. Further, by adjusting the amount of dumping performed by the resistor 72, it becomes possible to set the gain level at the downstream-signal output terminal 40 with high precision. Further, when the resistor 72 is inserted in series with the wiring between the amplifier 38 and the downstream-signal output terminal 40 as shown in FIG. 3, the amplifier 38 is prevented from being damaged by a surge current flowing from the downstream-signal output terminal 40. Consequently, the electrostatic withstand voltage of the downstream-signal output terminal 40 increases.

It should be understood that the foregoing description is only illustrative of the present invention. Various alternatives and modifications can be devised by those skilled in the art without departing from the present invention. Accordingly, the present invention is intended to embrace all such alternatives, modifications and variances which fall within the scope of the appended claims.

What is claimed is:

1. A CATV tuner, comprising:
an input circuit connected to an input terminal for transmitting and receiving a signal to and from a CATV station, the input circuit including an upstream-signal input terminal, a distributor, a low-pass filter, an amplifier, and a downstream-signal output terminal;
a first mixer circuit for mixing an output signal from the input circuit and a first local-oscillation signal so as to generate a first IF signal;
a first oscillation circuit for transmitting the first local-oscillation signal to the first mixer circuit;
a first IF circuit for processing the first IF signal;
a second mixer circuit for mixing an output signal from the first IF circuit and a second local-oscillation signal so as to generate a second IF signal; and
a second oscillation circuit for transmitting the second local-oscillation signal to the second mixer circuit; and
a second IF circuit for processing the second IF signal;
wherein at least one upstream signal is input to the upstream-signal input terminal so as to be transmitted to the CATV station, the distributor distributes a reception signal to generate distributed signals and transmits one of the distributed signals to the downstream-signal output terminal as a downstream signal so that the downstream signal is output therefrom, and the amplifier is arranged between the distributor and the downstream-signal output terminal so as to amplify the downstream signal, and the low-pass filter is arranged between the distributor and the amplifier so as to remove a CATV signal having a frequency that is higher than a predetermined upper limit frequency of the downstream signal.

2. A CATV tuner according to claim 1, further comprising a high-pass filter arranged between the distributor and the amplifier so as to block the upstream signal.

3. A CATV tuner according to claim 2, wherein the high-pass filter and the low-pass filter define a bandpass filter.

4. A CATV tuner according to claim 1, further comprising a resistor arranged between the amplifier and the downstream-signal output terminal.

5. A CATV tuner according to claim 2, further comprising a resistor arranged between the amplifier and the downstream-signal output terminal.

6. A CATV tuner according to claim 1, further comprising a tuner case having the input circuit provided therein.

7. A CATV tuner according to claim 1, wherein an output from one end of the distributor is transmitted to the downstream-signal output terminal via the low-pass filter and the amplifier.

8. A CATV tuner according to claim 1, wherein an output from one end of the distributor is subjected to processing and transmitted to the first mixer circuit.

9. A CATV tuner according to claim 6, wherein the amplifier is provided in the tuner case.

10. A CATV tuner according to claim 1, wherein the low-pass filter functions as a matching circuit for making the downstream signal transmitted from the distributor suitable to be input to the amplifier.
